(19) United States
(12) Patent Application Publication
(10) Pub. No.: US 2014/0108875 A1
(43) Pub. Date: Apr. 17, 2014

(54) Systems and Methods for Indirect Information Assisted Media Defect Scan

(71) Applicant: LSI CORPORATION, Milpitas, CA (US)

(72) Inventors: Ming Jin, Fremont, CA (US); Fan Zhang, Milpitas, CA (US); Haitao Xia, San Jose, CA (US)

(73) Assignee: LSI Corporation, Milpitas, CA (US)

(21) Appl. No.: 13/652,046

(22) Filed: Oct. 15, 2012

(51) Int. Cl. G11B 20/18; G06F 11/16

(52) U.S. Cl. 714/54; 360/53; G9B/20.046; 714/E11.062

(57) ABSTRACT

Systems, circuits, devices and/or methods related to systems and methods for data processing, and more particularly to systems and methods for media defect detection.

### BACKGROUND OF THE INVENTION

Some embodiments are related to systems and methods for data processing, and more particularly to systems and methods for media defect detection.

Various data transfer systems have been developed including storage systems. In such systems, data is accessed from a storage medium and processed to restore an originally written data set. In some cases, a defect on the storage medium makes it less possible to recover originally written data sets. Thus, it is advantageous to identify defective portions of the storage medium and to map the defective regions to avoid use thereof. Identifying such defective regions can be prone to misidentification.

Hence, for at least the aforementioned reasons, there exists a need in the art for advanced systems and methods for media defect detection.

### BRIEF SUMMARY

Some embodiments are related to systems and methods for data processing, and more particularly to systems and methods for media defect detection.

Various embodiments of the present invention provide data processing systems that include a media defect detection circuit and a media defect indication controller circuit. The media defect detection circuit is operable to apply a media defect detection algorithm to a data set derived from a region on a storage medium to yield a defect value indicator. The media defect indication controller circuit is operable to identify a media defect at the region on the storage medium based at least in part on indirect information in addition to the defect value indicator.

This summary provides only a general outline of some embodiments of the invention. The phrases “in one embodiment,” “according to one embodiment,” “in various embodiments”, “in one or more embodiments”, “in particular embodiments” and the like generally mean the particular feature, structure, or characteristic following the phrase is included in at least one embodiment of the present invention, and may be included in more than one embodiment of the present invention. Importantly, such phases do not necessarily refer to the same embodiment. Many other embodiments of the invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 shows a storage system including re-read information assisted media defect scanning circuitry in accordance with various embodiments of the present invention;

FIG. 2a depicts a media defect scanning and mapping circuit in accordance with one or more embodiments of the present invention;

FIG. 2b shows a data processing circuit that may be used in relation to the media defect scanning and mapping circuit of FIG. 2a;

FIG. 3 shows a method for media defect scanning and mapping in accordance with some embodiments of the present invention; and

FIGS. 4a-4b depict examples of media defect determination in accordance with some embodiments of the present invention.

### DETAILED DESCRIPTION OF SOME EMBODIMENTS

Some embodiments are related to systems and methods for data processing, and more particularly to systems and methods for media defect detection.

Various embodiments of the present invention provide media defect detection systems that utilize indirect information for media defect detection. In some cases, the media defect detection systems are operable to both scan for media defects and to map media defects. In particular cases, the defect detection systems are operable to identify one or more media defects, and to qualify the surety or likelihood of the media defect based on the re-read information. Where a potential media defect is identified that is highly likely to be an actual media defect, the potential media defect is indicated as an actual media defect and mapped. Alternatively, where a potential media defect is identified that is highly unlikely to be an actual media defect, the potential media defect is not indicated and not mapped. Where a potential media defect is identified that is neither highly likely nor highly unlikely to be an actual media defect, the physical proximity of the potential media defect to another previously identified media defect is determined. Where the physical proximity is within a defined limit, the potential media defect is identified as an actual defect and mapped. Otherwise, where the physical proximity is not within a defined limit, then the potential media defect is not indicated as an actual media defect or mapped.

Various embodiments of the present invention provide data processing systems that include a media defect detection circuit and a media defect indication controller circuit. The media defect detection circuit is operable to apply a media defect detection algorithm to a data set derived from a region on a storage medium to yield a defect value indicator. The media defect indication controller circuit is operable to identify a media defect at the region on the storage medium based at least in part on indirect information in addition to the defect value indicator. As used herein, the phrase “indirect information” is used in its broadest sense to mean information not directly provided by a media defect detector circuit. As one example, such indirect information may include the number of times a particular result is received from a media defect detector circuit. In some instances of the aforementioned embodiments, the system is implemented as an integrated circuit. In one or more instances of the aforementioned embodiments, the data processing system in a storage device.

In various instances of the aforementioned embodiments, the indirect information is a number of times that applying the media defect detection algorithm yielded the defect value indicator within a defined range. In some such instances, the defined range is greater than a first threshold and less than a second threshold. The first threshold and the second threshold may be user programmable. The defective region mapping circuit is operable to indicate the region from which the data set is derived as defective when a value of defect value indicator that is greater than the second threshold.

In one or more instances of the aforementioned embodiments, the data processing system further includes a defective region mapping circuit operable to indicate the region from which the data set is derived as defective when the number of times exceeds an incident threshold. In some such instances, the incident threshold is programmable. In some cases, the data processing systems further include: a proximity calculator circuit operable to calculate a proximity value of the region from which the data set is derived to a known defective region; and a defective region mapping circuit operable to indicate the region from which the data set is derived as defective when the number of times exceeds an incident threshold and the proximity value is less than a proximity threshold. In some such cases, the proximity threshold is user programmable. In one or more cases, the proximity value is calculated as a number of tracks between the region from which the data set is derived and the known defective region when the number of wedges between the region from which the data set is derived and the known defective region is less than a defined threshold.

Other embodiments of the present invention provide methods for data processing that include: applying a media defect detection algorithm to a data set derived from a region on a storage medium to yield a defect value indicator; and identifying a media defect at the region on the storage medium based at least in part on indirect information in addition to the defect value indicator. In some instances of the aforementioned embodiments, the indirect information is a number of times that applying the media defect detection algorithm yielded the defect value indicator within a defined range, and the methods further include indicating the region on the storage medium as defective when a value of defect value indicator is greater than a threshold. In various instances of the aforementioned embodiments, the indirect information is a number of times that applying the media defect detection algorithm yielded the defect value indicator within a defined range. The methods further include indicating the region on the storage medium as defective when the number of times exceeds an incident threshold. In various instances of the aforementioned embodiments, the indirect information is a number of times that applying the media defect detection algorithm yielded the defect value indicator within a defined range. The methods further include: calculating a proximity value of the region on the storage medium to a known defective region on the storage region; and indicating the region on the storage medium as defective when the number of times exceeds an incident threshold and the proximity value is less than a proximity threshold.

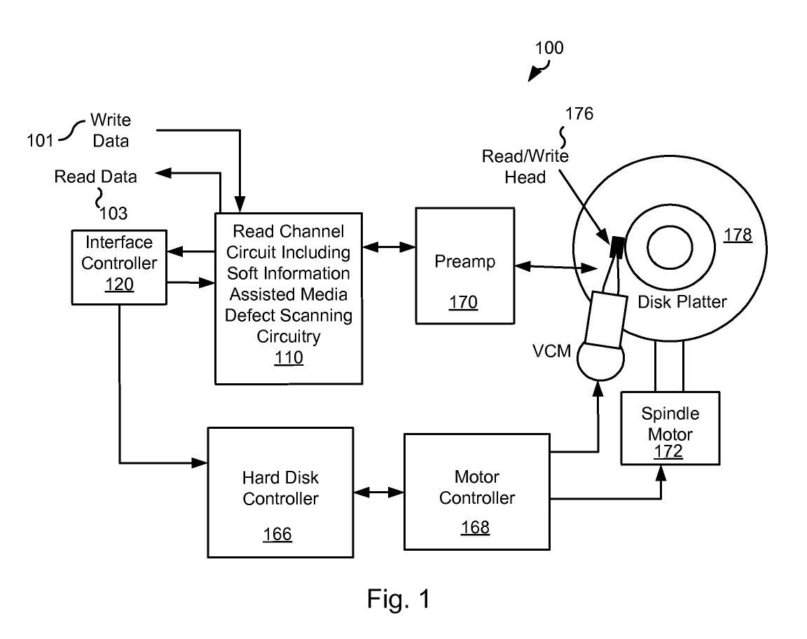

Turning to FIG. 1, a storage system 100 including a read channel circuit 110 having soft information assisted media defect scanning circuitry in accordance with various embodiments of the present invention is shown in accordance with various embodiments of the present invention. Storage system 100 may be, for example, a hard disk drive. Storage system 100 also includes a preamplifier 170, an interface controller 120, a hard disk controller 166, a motor controller 168, a spindle motor 172, a disk platter 178, and a read/write head 176. Interface controller 120 controls addressing and timing of data to/from disk platter 178. The data on disk platter 178 consists of groups of magnetic signals that may be detected by read/write head assembly 176 when the assembly is properly positioned over disk platter 178. In one embodiment, disk platter 178 includes magnetic signals recorded in accordance with either a longitudinal or a perpendicular recording scheme.

In a typical read operation, read/write head assembly 176 is accurately positioned by motor controller 168 over a desired data track on disk platter 178. Motor controller 168 both positions read/write head assembly 176 in relation to disk platter 178 and drives spindle motor 172 by moving read/write head assembly to the proper data track on disk platter 178 under the direction of hard disk controller 166. Spindle motor 172 spins disk platter 178 at a determined spin rate (RPMs). Once read/write head assembly 176 is positioned adjacent the proper data track, magnetic signals representing data on disk platter 178 are sensed by read/write head assembly 176 as disk platter 178 is rotated by spindle motor 172. The sensed magnetic signals are provided as a continuous, minute analog signal representative of the magnetic data on disk platter 178. This minute analog signal is transferred from read/write head assembly 176 to read channel circuit 110 via preamplifier 170. Preamplifier 170 is operable to amplify the minute analog signals accessed from disk platter 178. In turn, read channel circuit 110 decodes and digitizes the received analog signal to recreate the information originally written to disk platter 178. This data is provided as read data 103 to a receiving circuit. A write operation is substantially the opposite of the preceding read operation with write data 101 being provided to read channel circuit 110. This data is then encoded and written to disk platter 178.

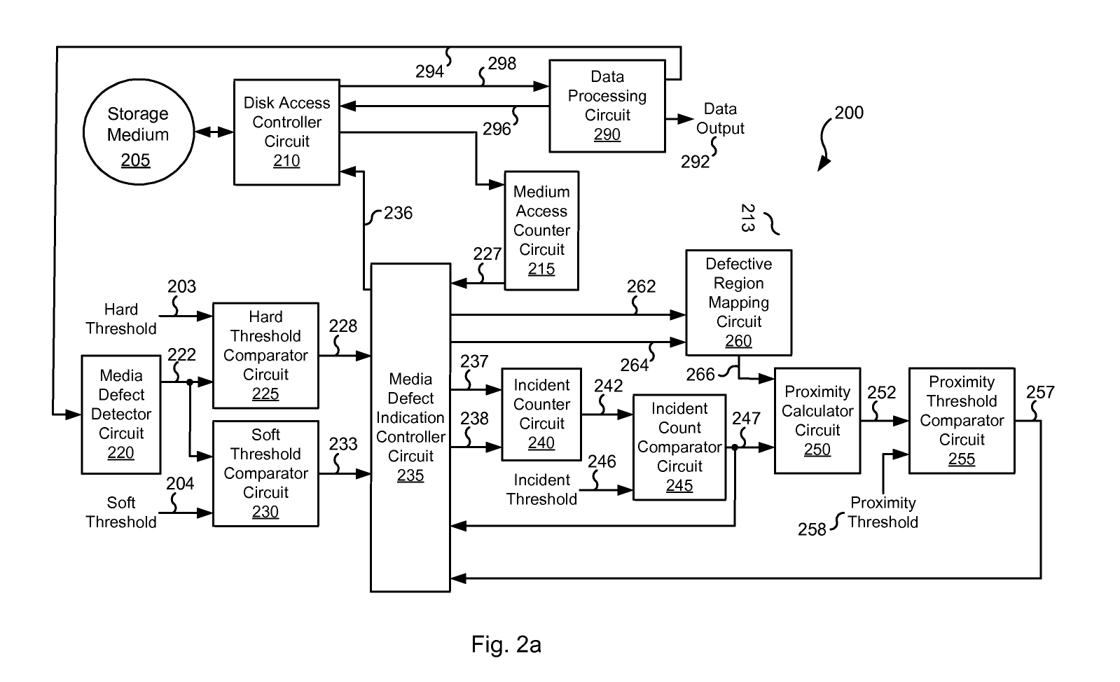

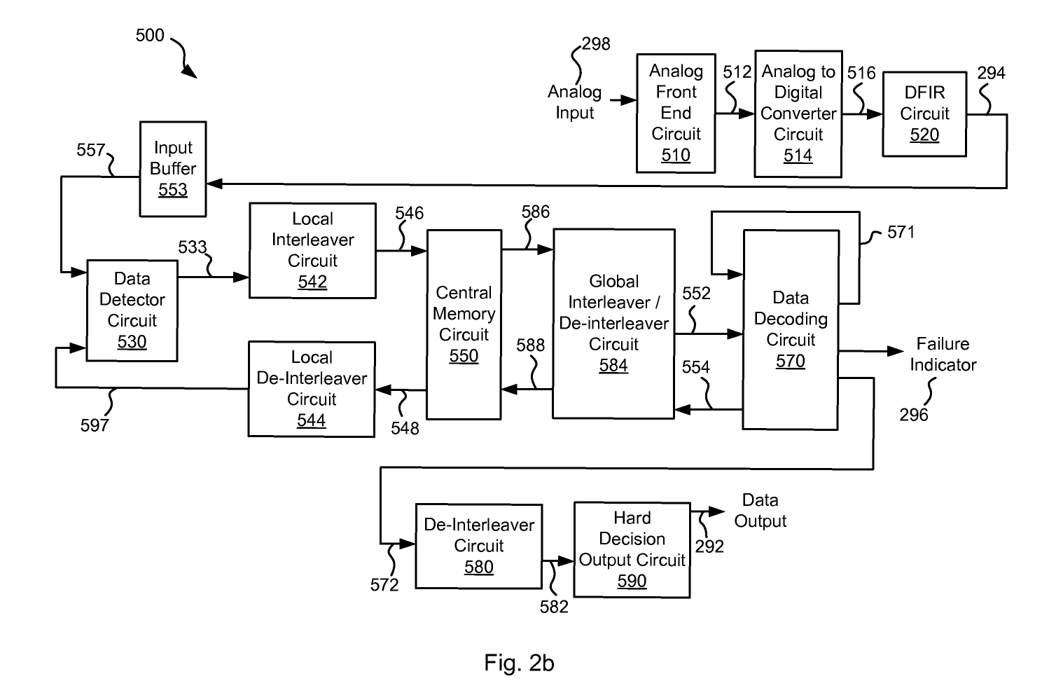

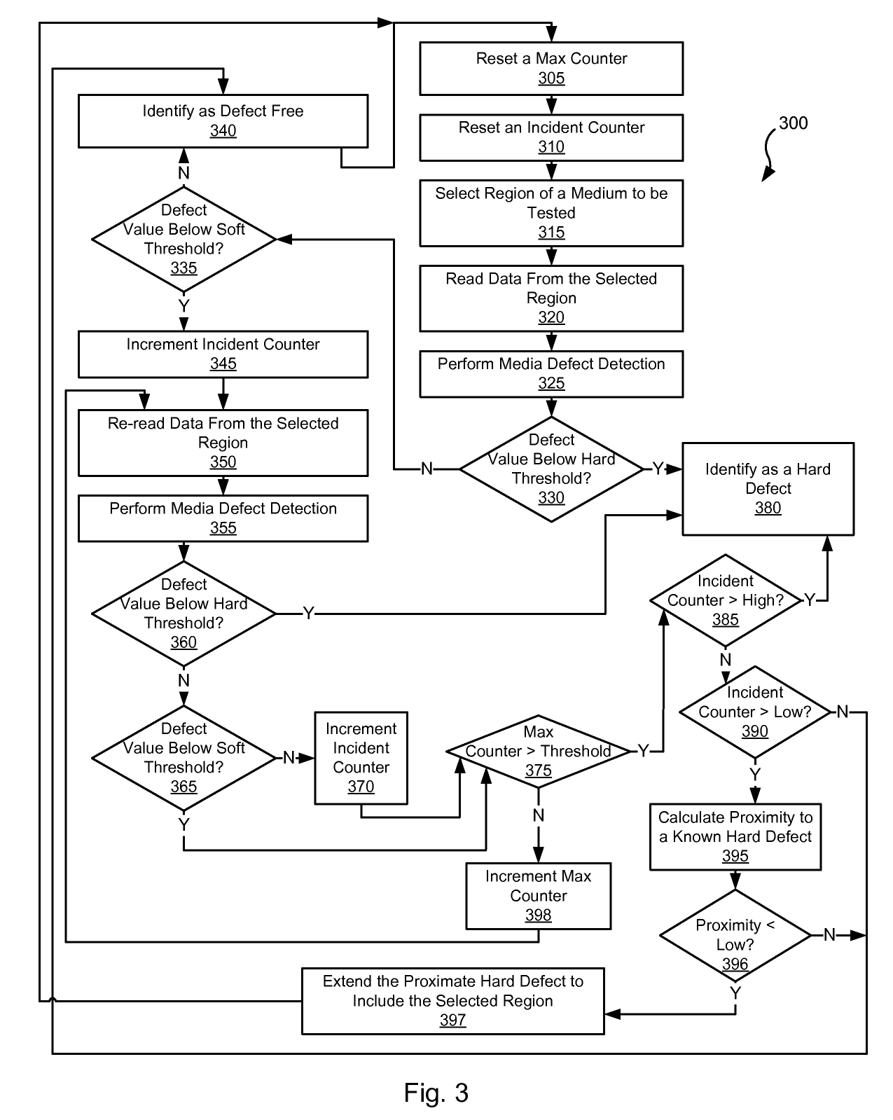

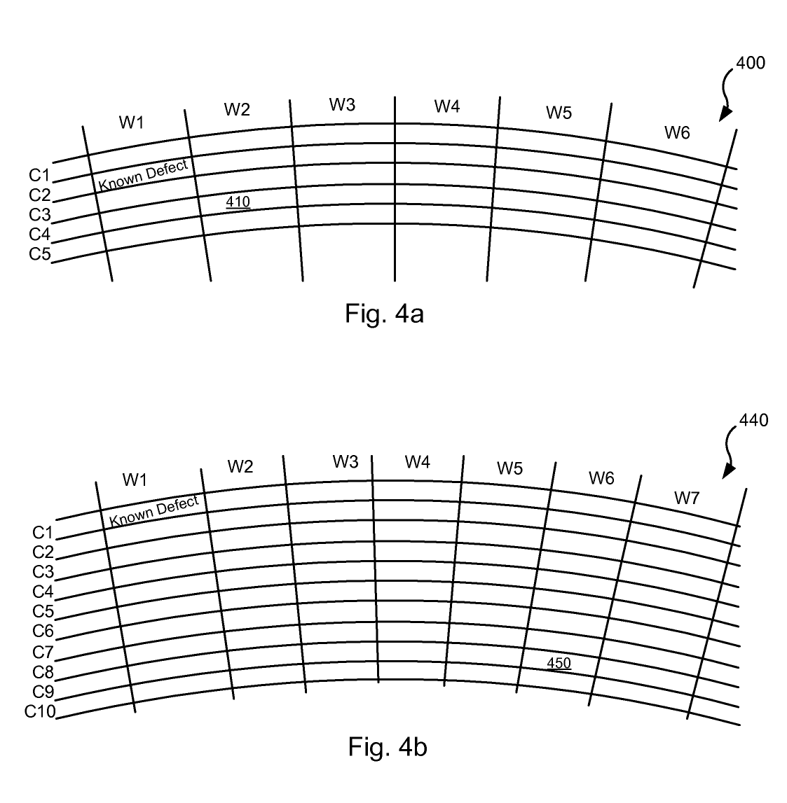

Either during manufacturing or after deployment of storage device, a media defect scan may be performed and in some cases and identified defects are mapped. Such mapping precludes later use of the identified defective regions. The soft information assisted media defect scanning circuitry utilizes soft information to determine the surety or likelihood of a defective region on a storage medium. Where a potential media defect is identified that is highly likely to be an actual media defect, the potential media defect is indicated as an actual media defect and mapped. Alternatively, where a potential media defect is identified that is highly unlikely to be an actual media defect, the potential media defect is not indicated and not mapped. Where a potential media defect is identified that is neither highly likely nor highly unlikely to be an actual media defect, the physical proximity of the potential media defect to another previously identified media defect is determined. Where the physical proximity is within a defined limit, the potential media defect is identified as an actual defect and mapped. Otherwise, where the physical proximity is not within a defined limit, then the potential media defect is not indicated as an actual media defect or mapped. In some cases, read channel circuit 110 may be implemented to include a media defect detection circuit similar to that discussed below in relation to FIG. 2a. Further, the processing may be accomplished consistent with one of the approaches discussed below in relation to FIGS. 3, and 4a-4c.

It should be noted that storage system 100 may be integrated into a larger storage system such as, for example, a RAID (redundant array of inexpensive disks or redundant array of independent disks) based storage system. Such a RAID storage system increases stability and reliability through redundancy, combining multiple disks as a logical unit. Data may be spread across a number of disks included in the RAID storage system according to a variety of algorithms and accessed by an operating system as if it were a single disk. For example, data may be mirrored to multiple disks in the RAID storage system, or may be sliced and distributed across multiple disks in a number of techniques. If a small number of disks in the RAID storage system fail or become unavailable, error correction techniques may be used to recreate the missing data based on the remaining portions of the data from the other disks in the RAID storage system. The disks in the RAID storage system may be, but are not limited to, individual storage systems such as storage system 100, and may be located in close proximity to each other or distributed more widely for increased security. In a write operation, write data is provided to a controller, which stores the write data across the disks, for example by mirroring or by striping the write data. In a read operation, the controller retrieves the data from the disks. The controller then yields the resulting read data as if the RAID storage system were a single disk.

A data decoder circuit used in relation to read channel circuit 110 may be, but is not limited to, a low density parity check (LDPC) decoder circuit as are known in the art. Such low density parity check technology is applicable to transmission of information over virtually any channel or storage of information on virtually any media. Transmission applications include, but are not limited to, optical fiber, radio frequency channels, wired or wireless local area networks, digital subscriber line technologies, wireless cellular, Ethernet over any medium such as copper or optical fiber, cable channels such as cable television, and Earth-satellite communications. Storage applications include, but are not limited to, hard disk drives, compact disks, digital video disks, magnetic tapes and memory devices such as DRAM, NAND flash, NOR flash, other non-volatile memories and solid state drives.

In addition, it should be noted that storage system 100 may be modified to include solid state memory that is used to store data in addition to the storage offered by disk platter 178. This solid state memory may be used in parallel to disk platter 178 to provide additional storage. In such a case, the solid state memory receives and provides information directly to read channel circuit 110. Alternatively, the solid state memory may be used as a cache where it offers faster access time than that offered by disk platted 178. In such a case, the solid state memory may be disposed between interface controller 120 and read channel circuit 110 where it operates as a pass through to disk platter 178 when requested data is not available in the solid state memory or when the solid state memory does not have sufficient storage to hold a newly written data set. Based upon the disclosure provided herein, one of ordinary skill in the art will recognize a variety of storage systems including both disk platter 178 and a solid state memory.

Turning to FIG. 2a, a media defect scanning and mapping circuit 200 is shown in accordance with one or more embodiments of the present invention. Media defect scanning and mapping circuit 200 includes a disk access controller circuit 210 that controls both reading data from a storage medium 205 and writing data to storage medium 205. In some embodiments of the present invention, storage medium 205 may be, but is not limited to, a magnetic storage medium or an optical storage medium. Based upon the disclosure provided herein, one of ordinary skill in the art will recognize a variety of storage media that may be used in place of storage medium 200. Disk access controller circuit 210 may be any circuit known in the art for controlling transfer of information to/from a storage medium.

Disk access controller circuit 210 provides an analog signal 298 derived from information maintained on storage medium 205 to a data processing circuit 290. Data processing circuit applies one or more data processing algorithms to analog signal 298 in an attempt to recover an original data set represented by the data set derived from storage medium and received as analog signal 298. Where the original data set is properly recovered, data processing circuit 290 provides the data set as a data output 292. Alternatively, where the data set is not properly recovered, data processing circuit 290 provides a failure indicator 296 to disk access controller circuit 210. Data processing circuit 290 includes a variety of processing circuitry, some of which generate an equalized output 294 from analog signal 298. Equalized output 294 is provided to a media defect detector circuit 220.

Media defect detector circuit 220 may be any circuit known in the art that is capable of providing an indication of a potential media defect on storage medium 205. As one example, a media defect detector similar to that discussed in U.S. patent application Ser. No. 13/088,119 entitled “Systems and Methods for Short Media Defect Detection” and filed by Zhang et al. may be used. The entirety of the aforementioned reference is incorporated herein by reference for all purposes. Based upon the disclosure provided herein, one of ordinary skill in the art will recognize a variety of media defect detection processes that may be used in relation to different embodiments of the present invention. The potential media defect is indicated as a defect value output 222. The magnitude of defect value output 222 corresponds to the likelihood that the potential media defect is an actual media defect. In this embodiment, the higher the value of defect value output 222 the more likely that the potential defect is an actual defect. It should be noted that in other embodiments, the lower the value of defect value output 222 the more likely that the potential defect is an actual defect.

Defect value output 222 is provided to a hard threshold comparator circuit 225 and a soft threshold comparator circuit 230. Hard threshold comparator circuit 225 compares defect value output 222 against a hard threshold value 203 to yield a hard result 228, and soft threshold comparator circuit 223 compares defect value output 222 against a soft threshold value 204 to yield a soft result 233. Both hard threshold 203 and soft threshold 204 may be user programmable values. When asserted high, hard result 228 indicates that defect value output 222 is greater than hard threshold 203. When asserted high, soft result 233 indicates that defect value output 222 is less than soft threshold 204.

Disk access controller circuit 210 moves on to the next region on storage medium 205 to be tested when a media defect indication controller circuit 235 asserts a re-read status signal 236 indicates testing of the given region is complete. Re-read status signal 236 indicates completion when media defect indication controller circuit 235 determines that the currently processing region on storage medium 205 has completed testing. Where testing is not complete, media defect indication controller circuit 235 asserts re-read status signal 236 indicate a re-read is expected to perform the next stage of the testing. Such testing is discussed in more detail below. In addition, based upon assertion of completion output 236, disk access controller circuit 210 asserts a control signal 213 to a medium access counter circuit 215 causing medium access counter circuit 215 to reset. Medium access controller circuit 215 is operable to count the number of times a given region on storage medium 205 is re-read by disk access controller circuit 210 during the processing, and a count value 227 indicating the number of times the given region on storage medium 205 is re-read by disk access controller circuit 210 is provided from medium access counter circuit 215 to media defect indication controller circuit 235.

Where testing is complete, media defect indication controller circuit 235 asserts a reset signal 238 to an incident counter circuit 240. Incident counter circuit 240 is operable to count the number of times defect value output 222 is in an ambiguous region between soft threshold 204 and hard threshold 203, and is reset whenever testing of a given region of storage medium 205 completes.

Soft result 233 and hard result 228 are provided to media defect indication controller circuit 235. Media defect indication controller circuit 235 controls the identification of a region of storage medium 205 as defective or free of defects. Where hard result 228 is asserted high (i.e., defect value output 222 is greater than hard threshold 203), media defect indication controller circuit 235 asserts a hard defect indicator 262 to a defective region mapping circuit 260. Based upon assertion of hard defect indicator 262, defective region mapping circuit 260 identifies the currently processing region of storage medium 205 as defective.

Where, on the other hand, hard result 228 is not asserted high (i.e., defect value output 222 is not greater than hard threshold 203), media defect indication controller circuit 235 de-asserts hard defect indicator 262 to defective region mapping circuit 260, and asserts an incident increment signal 237 operable to cause incident counter circuit 240 to increment. Incident counter circuit 242 provides an incident count 242 representing the number of times (i.e., the number of times reprocessing of the given region on storage medium 205) defect value output 222 is in an ambiguous region between soft threshold 204 and hard threshold 203 to an incident count comparator circuit 245. Incident count comparator circuit 245 compares incident count 242 against an incident threshold 246. Incident threshold 246 may be a user programmable value. The result of the comparison is provided by incident count comparator circuit 245 as a comparator result 247.

Comparator result 247 is provided as feedback to media defect indication controller circuit 235. In addition, comparator result 247 is provided to a proximity calculator circuit 250 along with a defective region indicator 266 from defective region mapping circuit 260. Where comparator result 247 indicates that incident count 242 is greater than incident threshold 246, proximity calculator circuit 250 calculates a proximity to the nearest known defect on storage medium 205 provided as defective region indicator 266. In one particular embodiment of the present invention where storage medium 205 is divided into regions by wedges and tracks, a proximity between the currently processing region (i.e., the selected region) and a known defect is calculated as a combination of wedge number (Wx) and track number (Cx) in accordance with the following equation:

$$Proximity = \{ \begin{matrix}\vert {C}_{selected} - {C}_{known} \vert , & if \vert {W}_{selected} - {W}_{known} \vert \leq Wedge Distance \\ + Maximum , & otherwise\end{matrix}$$

where C_{selected} and W_{selected} are the track number and wedge number, respectively, of the selected region; and C_{known} and W_{known} are the track number and wedge number, respectively, of the known defect. In some embodiments of the present invention, the Wedge Distance is a fixed value between two (2) and three (3). In other embodiments of the present invention, the Wedge Distance is user modifiable. This proximity value is provided as a proximity output 252.

Proximity output 252 is provided to a proximity threshold comparator circuit 255 where it is compared with a proximity threshold 258 to yield a proximity result 257 which is fed back to media defect indication controller circuit 235. Based upon hard result 228, soft result 233, count value 227, comparator result 247, and proximity result 257, media defect indication controller circuit 235 controls indication of a defective region by controlling hard defect indicator 262 and a soft defect indicator 264. The following pseudocode represents operation of media defect indication controller circuit 235.

/* repeat until count value 227 is equal to a maximum value */
If(hard result 228 = asserted){

assert hard defect indicator 262 to indicate a defect at the currently
processing region;
assert re-read status signal 236 indicating testing completion;
assert reset signal 238 to reset incident counter circuit 240

}
Else If(hard result 228 = de-asserted && soft result 233 = de-asserted){

assert incident increment signal 237 to cause incident counter circuit
240 to increment;
If(comparator result 247 = asserted){
assert soft defect indicator 264 identifying region identified by

proximity result 257 as defective;

```
  assert re-read status signal 236 indicating testing completion;
  assert reset signal 238 to reset incident counter circuit 240
}
If(count value 227 = maximum){
```

assert re-read status signal 236 indicating testing completion;
assert reset signal 238 to reset incident counter circuit 240

```
}
Else If(count value < maximum){
  assert re-read status signal 236 indicating re-read of the given
  region
}
```

Else If(hard result 228 = asserted) {

assert re-read status signal 236 indicating re-read of the given region

}

Turning to FIG. 2b, a data processing circuit 500 is depicted that may be used in place of data processing circuit 290 of media defect scanning and mapping circuit 200. Data processing circuit 500 includes analog front end circuit 510 that receives an analog input 298 from disk access controller circuit 210 described above in relation to FIG. 2a. Analog front end circuit 510 processes analog input 298 and provides a processed analog signal 512 to an analog to digital converter circuit 514. Analog front end circuit 510 may include, but is not limited to, an analog filter and an amplifier circuit as are known in the art. Based upon the disclosure provided herein, one of ordinary skill in the art will recognize a variety of circuitry that may be included as part of analog front end circuit 510.

Analog to digital converter circuit 514 converts processed analog signal 512 into a corresponding series of digital samples 516. Analog to digital converter circuit 514 may be any circuit known in the art that is capable of producing digital samples corresponding to an analog input signal. Based upon the disclosure provided herein, one of ordinary skill in the art will recognize a variety of analog to digital converter circuits that may be used in relation to different embodiments of the present invention. Digital samples 516 are provided to an equalizer circuit 520. Equalizer circuit 520 applies an equalization algorithm to digital samples 516 to yield equalized output 294. As described above, equalized output is provided to media defect detector circuit 220 described above in relation to FIG. 2a. In some embodiments of the present invention, equalizer circuit 220 is a digital finite impulse response filter circuit as are known in the art. It may be possible that equalized output 294 may be received directly from a storage device in, for example, a solid state storage system. Equalized output 294 is stored to an input buffer 553 that includes sufficient memory to maintain a number of codewords until processing of that codeword is completed through a data detector circuit 530 and a data decoding circuit 570 including, where warranted, multiple global iterations (passes through both data detector circuit 530 and data decoding circuit 570) and/or local iterations (passes through data decoding circuit 570 during a given global iteration). An output 557 is provided to data detector circuit 530.

Data detector circuit 530 may be a single data detector circuit or may be two or more data detector circuits operating in parallel on different codewords. Whether it is a single data detector circuit or a number of data detector circuits operating in parallel, data detector circuit 530 is operable to apply a data detection algorithm to a received codeword or data set. In some embodiments of the present invention, data detector circuit 530 is a Viterbi algorithm data detector circuit as are known in the art. In other embodiments of the present invention, data detector circuit 530 is a maximum a posteriori data detector circuit as are known in the art. Of note, the general phrases “Viterbi data detection algorithm” or “Viterbi algorithm data detector circuit” are used in their broadest sense to mean any Viterbi detection algorithm or Viterbi algorithm detector circuit or variations thereof including, but not limited to, bi-direction Viterbi detection algorithm or bi-direction Viterbi algorithm detector circuit. Also, the general phrases “maximum a posteriori data detection algorithm” or “maximum a posteriori data detector circuit” are used in their broadest sense to mean any maximum a posteriori detection algorithm or detector circuit or variations thereof including, but not limited to, simplified maximum a posteriori data detection algorithm and a max-log maximum a posteriori data detection algorithm, or corresponding detector circuits. Based upon the disclosure provided herein, one of ordinary skill in the art will recognize a variety of data detector circuits that may be used in relation to different embodiments of the present invention. In some cases, one data detector circuit included in data detector circuit 530 is used to apply the data detection algorithm to the received codeword for a first global iteration applied to the received codeword, and another data detector circuit included in data detector circuit 530 is operable apply the data detection algorithm to the received codeword guided by a decoded output accessed from a central memory circuit 550 on subsequent global iterations.

Upon completion of application of the data detection algorithm to the received codeword on the first global iteration, data detector circuit 530 provides a detector output 533. Detector output 533 includes soft data. As used herein, the phrase “soft data” is used in its broadest sense to mean reliability data with each instance of the reliability data indicating a likelihood that a corresponding bit position or group of bit positions has been correctly detected. In some embodiments of the present invention, the soft data or reliability data is log likelihood ratio data as is known in the art. Detector output 533 is provided to a local interleaver circuit 542. Local interleaver circuit 542 is operable to shuffle sub-portions (i.e., local chunks) of the data set included as detected output and provides an interleaved codeword 546 that is stored to central memory circuit 550. Interleaver circuit 542 may be any circuit known in the art that is capable of shuffling data sets to yield a re-arranged data set. Interleaved codeword 546 is stored to central memory circuit 550.

Once a data decoding circuit 570 is available, a previously stored interleaved codeword 546 is accessed from central memory circuit 550 as a stored codeword 586 and globally interleaved by a global interleaver/de-interleaver circuit 584. Global interleaver/de-interleaver circuit 584 may be any circuit known in the art that is capable of globally rearranging codewords. Global interleaver/De-interleaver circuit 584 provides a decoder input 552 into data decoding circuit 570. In some embodiments of the present invention, the data decode algorithm is a low density parity check algorithm as are known in the art. Based upon the disclosure provided herein, one of ordinary skill in the art will recognize other decode algorithms that may be used in relation to different embodiments of the present invention. Data decoding circuit 570 applies a data decode algorithm to decoder input 552 to yield a decoded output 571. In cases where another local iteration (i.e., another pass trough data decoder circuit 570) is desired, data decoding circuit 570 re-applies the data decode algorithm to decoder input 552 guided by decoded output 571. This continues until either a maximum number of local iterations is exceeded or decoded output 571 converges (i.e., completion of standard processing).

Where decoded output 571 fails to converge (i.e., fails to yield the originally written data set) and a number of local iterations through data decoder circuit 570 exceeds a threshold, the resulting decoded output is provided as a decoded output 554 back to central memory circuit 550 where it is stored awaiting another global iteration through a data detector circuit included in data detector circuit 530. Prior to storage of decoded output 554 to central memory circuit 550, decoded output 554 is globally de-interleaved to yield a globally de-interleaved output 588 that is stored to central memory circuit 550. The global de-interleaving reverses the global interleaving earlier applied to stored codeword 586 to yield decoder input 552. When a data detector circuit included in data detector circuit 530 becomes available, a previously stored de-interleaved output 588 is accessed from central memory circuit 550 and locally de-interleaved by a de-interleaver circuit 544. De-interleaver circuit 544 re-arranges decoder output 548 to reverse the shuffling originally performed by interleaver circuit 542. A resulting de-interleaved output 597 is provided to data detector circuit 530 where it is used to guide subsequent detection of a corresponding data set previously received as equalized output 294.

Alternatively, where the decoded output converges (i.e., yields the originally written data set), the resulting decoded output is provided as an output codeword 572 to a de-interleaver circuit 580 that rearranges the data to reverse both the global and local interleaving applied to the data to yield a de-interleaved output 582. De-interleaved output 582 is provided to a hard decision output circuit 590 that arranges the received codeword along with other previously received codewords in an order expected by a requesting host processor. In some cases, for example, thirty-two codewords may be requested by a host in one request. Hard decision output circuit 590 assembles the requested thirty-two codewords in a desired order and provides the ordered codewords as a data output 292.

Where decoded output 571 fails to converge (i.e., fails to yield the originally written data set), a number of local iterations through data decoder circuit 570 exceeds a threshold, and no more global iterations are allowed during standard processing of the corresponding data set maintained in input buffer 553, data decoding circuit 570 asserts failure indicator 296 that is provided to disk access controller circuit 210 discussed above in relation to FIG. 2a.

Turning to FIG. 3, a flow diagram 300 shows a method for media defect scanning and mapping in accordance with some embodiments of the present invention. Following flow diagram 300, a max counter is reset (block 305) and an incident counter (block 310) is reset each in preparation for testing a region on a storage medium. A region of a storage medium to be tested is selected (block 315). In some embodiments of the present invention, the storage medium is a radial magnetic storage medium such as those commonly found in a hard disk drive device. In such an embodiment, the region of a storage medium selected for testing is a wedge of a particular track of the storage medium. Based upon the disclosure provided herein, one of ordinary skill in the art will recognize a variety of storage media that may be tested, and a variety of portions of such storage media.

Data is read from the selected region of the storage medium (block 320), and a media defect detection is performed on the read data (block 325). The media defect detection may be any media defect detection process known in the art that is capable of yielding a metric indicative of the likelihood of a media defect in the selected region. As one example, a media defect detector circuit may be implemented to yield a range of signal values over a period, with a higher range indicating a low probability of a media defect, and a lower range indicating a higher possibility of a media defect. As one example, a media defect detection process similar to that discussed in U.S. patent application Ser. No. 13/088,119 entitled “Systems and Methods for Short Media Defect Detection” and filed by Zhang et al. may be used. Based upon the disclosure provided herein, one of ordinary skill in the art will recognize a variety of media defect detection processes that may be used in relation to different embodiments of the present invention. The resulting value of the media defect detection is indicative of the likelihood of a media defect.

For the purposes of this embodiment, it is assumed that the higher the value of the result of the media defect detection, the more likely it is that a media defect exists. It should be noted that in other embodiments a higher value may indicate a lower likelihood that a media defect exists. The result of the media defect detection is compared with a hard threshold (block 330). Where the result is less than the hard threshold (i.e., a high probability of a media defect) (block 330), a hard defect is identified (block 380). This identification may include mapping out the selected region to disallow future use of the selected region. In some cases, the hard threshold is user programmable.

Alternatively, where the result is not less than the hard threshold (block 330), the result of the media defect detection is compared with a soft threshold (block 335). Similar to the hard threshold, the soft threshold may also be user programmable. Where the result is less than the soft threshold (i.e., a low probability of a media defect) (block 335), the selected region of the storage medium is identified as being fee of defects (block 340). Alternatively, where the result is not less than the soft threshold (i.e., neither a low probability of a media defect nor a high probability of a media defect) (block 335), the incident counter is incremented (block 345). The incident counter counts the number of times a selected region is read without being either a high probability of a media defect or a low probability of a media defect. Data is then re-read from the selected region (block 350) and the media defect detection is performed on the re-read data (block 355).

The result of the media defect detection is compared with a hard threshold (block 360). Where the result is less than the hard threshold (i.e., a high probability of a media defect) (block 360), a hard defect is identified (block 380). Again, this identification may include mapping out the selected region to disallow future use of the selected region. On the other hand, where the result is not less than the hard threshold (block 360), it is determined whether the result is less than the soft threshold (block 365).

Where the result is not less than the soft threshold (block 365), the incident counter is incremented (block 370). Regardless of the comparison of the result with the soft threshold, it is determined whether the max counter is greater than a threshold (block 375). the threshold may be user programmable. Where the max counter is not greater than the threshold (block 375), the max counter is incremented (block 398) and the processes of blocks 250, 355, 360, 365, 370, 375 are repeated.

Alternatively, where the max counter is greater than the threshold (block 375), the incident counter is compared against a high threshold value (block 385). The high threshold value may be user programmable. Where the incident counter is greater than the high threshold value (block 385), a hard defect is identified (block 380). Again, this identification may include mapping out the selected region to disallow future use of the selected region. On the other hand, where the incident counter is not greater than the high threshold value (block 385), the incident counter is compared against a low threshold value (block 390). The low threshold value may be user programmable. Where the incident counter is not greater than the low threshold value (block 390), the selected region of the storage medium is identified as being fee of defects (block 340).

Otherwise, where the incident counter is greater than the low threshold value (block 390), the closest defective region on the storage medium (i.e., known hard defect) is identified and a proximity of the selected region to the closest defective region is calculated (block 395). It is then determined whether the proximity is less than a defined low value (block 396). The defined low value may be user programmable. Where the proximity is not less than the defined low value (block 396), the selected region of the storage medium is identified as being fee of defects (block 340). Alternatively, where the proximity is less than the defined low value (block 396), the proximate hard defect (i.e., the closest identified defect) is extended to include the selected region (block 397).

In one particular embodiment of the present invention, a proximity between the selected region and a known hard defect is calculated as a combination of wedge number (Wx) and track number (Cx) in accordance with the following equation:

$$Proximity = \{ \begin{matrix}\vert {C}_{selected} - {C}_{known} \vert , & if \vert {W}_{selected} - {W}_{known} \vert \leq Wedge Distance \\ + Maximum , & otherwise\end{matrix}$$

where C_{selected} and W_{selected} are the track number and wedge number, respectively, of the selected region; and C_{known} and W_{known} are the track number and wedge number, respectively, of the known defect. In some embodiments of the present invention, the Wedge Distance is a fixed value between two (2) and three (3). In other embodiments of the present invention, the Wedge Distance is user modifiable. Turning to FIGS. 4a-4b, examples 400, 440 of media defect determination are illustrated in accordance with some embodiments of the present invention.

Using example 400 of FIG. 4a, the closest known defect exists at wedge 1 (W1), track 2 (C2). A selected region 410 is being tested for defects. Where the media defect detection yields a result that is less than a hard threshold (e.g., block 330 or block 360 of FIG. 3), selected region 410 is identified as defective. Alternatively, where the incident counter is less than the high value and greater than the low value (e.g., blocks 385, 390 of FIG. 3), the closest known defect is identified. In this case, the closest known defect is at W1, C2. The proximity is calculated (e.g., block 395 of FIG. 3) to the closest known defect using the following equation relying on an example fixed wedge distance value of three (3):

$$Proximity = \{ \begin{matrix}\vert {C}_{selected} - {C}_{known} \vert , & if \vert {W}_{selected} - {W}_{known} \vert \leq 3 \\ + Maximum , & otherwise .\end{matrix}$$

In this case, |W_{selected}−W_{known}| is equal to one (1), and thus the proximity is equal |C_{selected}−C_{known}| or two (2). Where two is less than the defined low value, the known defect at W1, C2 is extended to include the selected region of W2, C4 (e.g., block 397 of FIG. 3). Where, on the other hand, the incident counter is less than the low value (block 390) or two is not less tan the defined low value, selected region 410 is identified as defect free (e.g., block 340 of FIG. 3).

Using example 440 of FIG. 4b, the closest known defect exists at wedge 1 (W1), track 1 (C1). A selected region 450 is being tested for defects. Where the media defect detection yields a result that is less than a hard threshold (e.g., block 330 or block 360 of FIG. 3), selected region 450 is identified as defective. Alternatively, where the incident counter is less than the high value and greater than the low value (e.g., blocks 385, 390 of FIG. 3), the closest known defect is identified. In this case, the closest known defect is at W1, C1. The proximity is calculated (e.g., block 395 of FIG. 3) to the closest known defect using the following equation relying on an example fixed wedge distance value of three (3):

$$Proximity = \{ \begin{matrix}\vert {C}_{selected} - {C}_{known} \vert , & if \vert {W}_{selected} - {W}_{known} \vert \leq 3 \\ + Maximum , & otherwise .\end{matrix}$$

In this case, |W_{selected}−W_{known}| is equal to five (5), and thus the proximity is equal the maximum value which is set to be to high to cause an extension of the defective region to include the selected region (block 396). Thus, selected region 450 is identified as defect free. Where, on the other hand, the incident counter is less than the low value (block 390), selected region 410 is identified as defect free (e.g., block 340 of FIG. 3).

It should be noted that the various blocks discussed in the above application may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent. In other cases, the one part of a given system, block or circuit may be implemented in software or firmware, while other parts are implemented in hardware.

In addition, it should be noted that while the embodiments above have been discussed as modifying a defect indication based upon a number of re-reads that are performed with ambiguous results (i.e., between a hard threshold and a soft threshold), other indirect information in addition to the number of re-reads or in place of the number of re-reads may be used in relation to different embodiments of the present invention. Such indirect information may include, but is not limited to, a range of changes required for a variable gain amplifier, soft data (e.g., log likelihood data) generated in the data processing circuit, and/or a magnitude of timing errors identified in one or more feedback loops associated with the data processing circuit. Further, while embodiments disclosed herein are directed to user data regions on a storage medium, the approaches discussed herein may be applied to servo data regions.

In conclusion, the invention provides novel systems, devices, methods and arrangements for priority based data processing. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A data processing system, the data processing system comprising:
a media defect detection circuit operable to apply a media defect detection algorithm to a data set derived from a region on a storage medium to yield a defect value indicator; and
a media defect indication controller circuit operable to identify a media defect at the region on the storage medium based at least in part on indirect information in addition to the defect value indicator.

2. The data processing system of claim 1, wherein the indirect information is a number of times that applying the media defect detection algorithm yielded the defect value indicator within a defined range.

3. The data processing system of claim 2, wherein the defined range is greater than a first threshold and less than a second threshold.

4. The data processing system of claim 3, wherein the data processing system further comprises:
a defective region mapping circuit operable to indicate the region from which the data set is derived as defective when a value of defect value indicator that is greater than the second threshold.

5. The data processing system of claim 3, wherein the first threshold and the second threshold are programmable.

6. The data processing system of claim 2, wherein the data processing system further comprises:
a defective region mapping circuit operable to indicate the region from which the data set is derived as defective when the number of times exceeds an incident threshold.

7. The data processing system of claim 6, wherein the incident threshold is programmable.

8. The data processing system of claim 2, wherein the data processing system further comprises:
a proximity calculator circuit operable to calculate a proximity value of the region from which the data set is derived to a known defective region; and
a defective region mapping circuit operable to indicate the region from which the data set is derived as defective when the number of times exceeds an incident threshold and the proximity value is less than a proximity threshold.

9. The data processing system of claim 8, wherein the proximity threshold is user programmable.

10. The data processing system of claim 8, wherein the proximity value is calculated as a number of tracks between the region from which the data set is derived and the known defective region when the number of wedges between the region from which the data set is derived and the known defective region is less than a defined threshold.

11. The data processing system of claim 1, wherein the system is implemented as an integrated circuit.

12. The data processing system of claim 1, wherein the data processing system is incorporated in a storage device.

13. A method for data processing, the method comprising:
applying a media defect detection algorithm to a data set derived from a region on a storage medium to yield a defect value indicator; and
identifying a media defect at the region on the storage medium based at least in part on indirect information in addition to the defect value indicator.

14. The method of claim 13, wherein the indirect information is a number of times that applying the media defect detection algorithm yielded the defect value indicator within a defined range, wherein the method further comprises:
indicating the region on the storage medium as defective when a value of defect value indicator is greater than a threshold.

15. The method of claim 13, wherein the indirect information is a number of times that applying the media defect detection algorithm yielded the defect value indicator within a defined range, wherein the method further comprises:
indicating the region on the storage medium as defective when the number of times exceeds an incident threshold.

16. The method of claim 13, wherein the indirect information is a number of times that applying the media defect detection algorithm yielded the defect value indicator within a defined range, wherein the method further comprises:
calculating a proximity value of the region on the storage medium to a known defective region on the storage region; and
indicating the region on the storage medium as defective when the number of times exceeds an incident threshold and the proximity value is less than a proximity threshold.

17. A storage device, the storage device comprising:
a storage medium;
a head assembly disposed in relation to the storage medium and operable to provide a sensed signal corresponding to information from a region on the storage medium;
a read channel circuit including:
an analog to digital converter circuit operable to sample an analog signal derived from the sensed signal to yield a series of digital samples;
an equalizer circuit operable to equalize the digital samples to yield an equalized output;
a media defect detection circuit operable to apply a media defect detection algorithm to the equalized output to yield a defect value indicator; and
a media defect indication controller circuit operable to identify a media defect at the region on the storage medium based at least in part on indirect information in addition to the defect value indicator.

18. The storage device of claim 17, wherein the indirect information is a number of times that applying the media defect detection algorithm yielded the defect value indicator within a defined range, wherein the storage device further comprises:
a defective region mapping circuit operable to indicate the region on the storage medium as defective when a value of defect value indicator is greater than a threshold.

19. The storage device of claim 17, wherein the indirect information is a number of times that applying the media defect detection algorithm yielded the defect value indicator within a defined range, wherein the storage device further comprises:
a defective region mapping circuit operable to indicate the region on the storage medium as defective when the number of times exceeds an incident threshold.

20. The storage device of claim 17, wherein the indirect information is a number of times that applying the media defect detection algorithm yielded the defect value indicator within a defined range, wherein the storage device further comprises:
a proximity calculator circuit operable to calculate a proximity value of the region on the storage medium to a known defective region on the storage region; and
a defective region mapping circuit operable to indicate the region on the storage medium as defective when the number of times exceeds an incident threshold and the proximity value is less than a proximity threshold.
